(19) United States
(12) Patent Application Publication
(10) Pub. No.: US 2025/0377822 A1
(43) Pub. Date: Dec. 11, 2025

(54) HOST-CONTROLLED BLOCK MAINTENANCE OPERATIONS

(71) Applicant: Micron Technology, Inc., Boise, ID (US)

(72) Inventor: Yanhua Bi, Shanghai (CN)

(21) Appl. No.: 19/213,537

(22) Filed: May 20, 2025

Related U.S. Application Data
(60) Provisional application No. 63/658,709, filed on Jun. 11, 2024.

(51) Int. Cl. G06F 3/06

(52) U.S. Cl. CPC G06F 3/0652; G06F 3/061; G06F 3/0673

(57) ABSTRACT

Methods, systems, and devices for host-controlled block maintenance operations are described. A host system may receive the block status information from a memory system in response to transmitting a request for the block status information. The block status information may include an indication of a first quantity of blocks available for writing and an indication of a second quantity of blocks written with at least a threshold amount of valid data. In accordance with the block status information and a target performance metric, the host system may transmit an indication for the memory system to perform, during an idle time, a block maintenance operation in which data stored at the second quantity of blocks is copied to a subset of the first quantity of blocks and in which the second quantity of blocks are erased after the data stored at the second quantity of blocks is copied.

### CROSS REFERENCE

The present application for patent claims priority to U.S. Patent Application No. 63/658,709 by Bi, entitled “HOST-CONTROLLED BLOCK MAINTENANCE OPERATIONS,” filed Jun. 11, 2024, which is assigned to the assignee hereof, and which is expressly incorporated by reference in its entirety herein.

### TECHNICAL FIELD

The following relates to one or more systems for memory, including host-controlled block maintenance operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports host-controlled block maintenance operations in accordance with examples as disclosed herein.

FIG. 2 shows an example of a system that supports host-controlled block maintenance operations in accordance with examples as disclosed herein.

FIG. 3 shows an example of a process flow that supports host-controlled block maintenance operations in accordance with examples as disclosed herein.

FIG. 4 shows a block diagram of a host system that supports host-controlled block maintenance operations in accordance with examples as disclosed herein.

FIG. 5 shows a block diagram of a memory system that supports host-controlled block maintenance operations in accordance with examples as disclosed herein.

FIGS. 6 and 7 show flowcharts illustrating a method or methods that support host-controlled block maintenance operations in accordance with examples as disclosed herein.

### DETAILED DESCRIPTION

To free up (e.g., make available for writing and/or other operations) blocks of a memory system, the memory system may perform a block maintenance operation (e.g., a garbage collection operation) in which the memory system copies valid data from one or more source blocks to one or more destination blocks, and prepares (e.g., erases) the source block(s) for writing. The memory system may use a source validity threshold to determine which blocks to use as source blocks for block maintenance. Blocks that fail to satisfy the source validity threshold may be used as source blocks for block maintenance in the background (e.g., during an idle time in which access commands from a host system are paused). Blocks that satisfy the source validity threshold may be used as source blocks for block maintenance in the foreground (e.g., during a time in which access commands from the host system are being received) if the quantity of available (e.g., erased) blocks falls below a threshold. But the source validity threshold used by the memory system may result in an insufficient amount of source blocks for background block maintenance operations, an excessive amount of source blocks for foreground block maintenance, or both, each of which may negatively impact overall system performance.

According to the techniques described herein, a host system may improve system performance by dynamically selecting the source validity threshold used by the memory system to select source blocks for background block maintenance operations. The host system may request block status information such as the quantity of available (e.g., erased) blocks at the memory system and the quantity of blocks that satisfy the candidate source validity threshold. If a performance metric (e.g., storage capacity) associated with the block status information satisfies a target performance metric determined by the host system, the host system may prompt and/or otherwise instruct the memory system to use that source validity threshold for background block maintenance operations. Otherwise, the host system may select a different source validity threshold to prompt and/or otherwise instruct the memory system. Thus, the source validity threshold may be dynamically selected (e.g., activated) based on (e.g., as a function of) the current block status of the memory system and one or more target performance metric(s) of the host system.

In addition to applicability in memory systems as described herein, techniques for host-controller block maintenance operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may [decrease processing or latency times, improve response times, or otherwise improve user experience, among other benefits.

In addition to applicability in memory systems as described herein, techniques for host-controlled block maintenance operations may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices, among other benefits.

Features of the disclosure are illustrated and described in the context of systems, devices, and circuits. Features of the disclosure are further illustrated and described in the context of a process flow, device diagrams, and flowcharts.

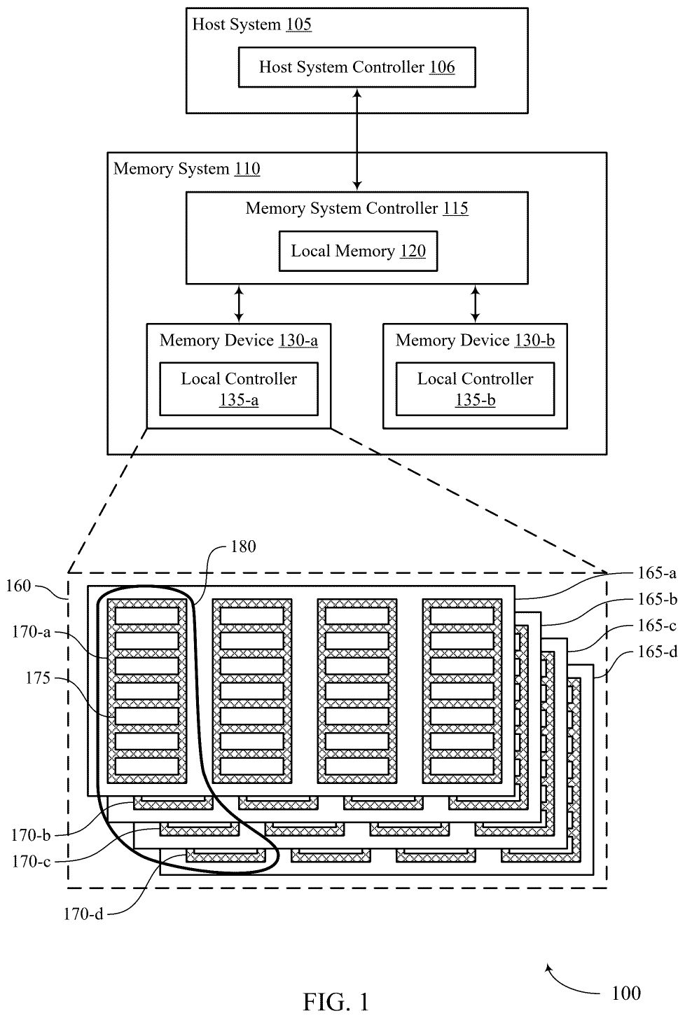

FIG. 1 shows an example of a system 100 that supports host-controlled block maintenance operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

As the data stored at the memory system 110 is updated, the amount of valid data stored in the blocks of the memory system may change, where valid data refers to data that is up-to-date and invalid data refers to data that is out-of-date. The memory system 110 may support page-basis writing, so the blocks of the memory system 110 may have varying amounts of valid data. However, the memory system 110 may perform erase operations on a block-basis instead of a page-basis (and write operations may be limited to pages that are erased), so a block may be unavailable for writing even if the amount of valid data written to the block is low. Put another way, the memory system 110 may be prevented from writing to a block even if the block only stores a small amount of valid data.

To increase the available storage capacity of the memory system 110, the memory system 110 may use a block maintenance operation, referred to as a garbage collection operation, that condenses valid data and frees up already-written blocks for writing. During the block maintenance operation, valid data from one or more source blocks may be copied to one or more destination blocks. For example, valid data from two source blocks each with 50% valid data may be copied to a destination block so that the destination block has 100% valid data. Thus, the overall increase in available storage capacity may increase by one block. The available storage capacity of the memory system 110 may refer to the collective storage capacity of the available (e.g., erased) blocks of the memory system 110. A block maintenance operation may refer to an individual copy/erase operation that transfers valid data to a destination block (e.g., from one or more source blocks) or to the collection of copy/erase operations that transfer valid data to a set of destination blocks (e.g., from a set of source blocks).

The latency associated with a block maintenance operation may be proportional to the amount of valid data stored in the source blocks(s) whereas the amount of available storage capacity freed up by the block maintenance operation may be inversely proportional to the amount of valid data stored in the source blocks(s). So, the latency and storage capacity impact associated with use of a block as a source block may vary with the amount of valid data stored by the block. Accordingly, the latency and storage capacity impact associated with a block maintenance operation may be based on (e.g., a function of) the source validity threshold.

In some other systems, the memory system 110 may use a static source validity threshold to select source blocks for background block maintenance operations (and for foreground block maintenance operations). But the static source validity threshold may not accommodate various performance metrics of the host system 105. For example, a source validity threshold that is too low may increase the quantity of source blocks for foreground block maintenance operations, which may increase the latency of the memory system 110 responding to access commands (e.g., SCSI commands) from the host system 105. On the other hand, a source validity threshold that is too high may increase the quantity of source blocks for background block maintenance operations, which may waste processing resources and increase power consumption.

According to the techniques described herein, the performance (e.g., available storage capacity, latency) of the system 100 may be improved, relative to other techniques, by dynamically selecting the source validity threshold used by the memory system 110 to identify source blocks for background block maintenance operations. To do so, the host system 105 may determine a target performance metric (e.g., an available storage capacity) for the memory system 110. The host system 105 may request block status information (e.g., the current quantity of free blocks at the memory system 110, the current quantities of blocks that satisfy various source block validity thresholds) that the host system 105 uses to select a source block validity threshold for the memory system 110. For instance, the host system 105 may select the source validity threshold that is associated with an expected performance metric that satisfies the target performance metric. Thus, the host system 105 may effectively shift some blocks from being source blocks for foreground block maintenance operations to being source blocks for background block maintenance operations (or vice versa). A source validity threshold may represent an amount of valid data (e.g., x MB) stored by a block, a percentage of valid data (e.g., 80%) stored by a block, or a ratio of valid data to invalid data (e.g., 2:1) stored by a block, among other examples.

The system 100 may include any quantity of non-transitory computer readable media that support host-controlled block maintenance operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

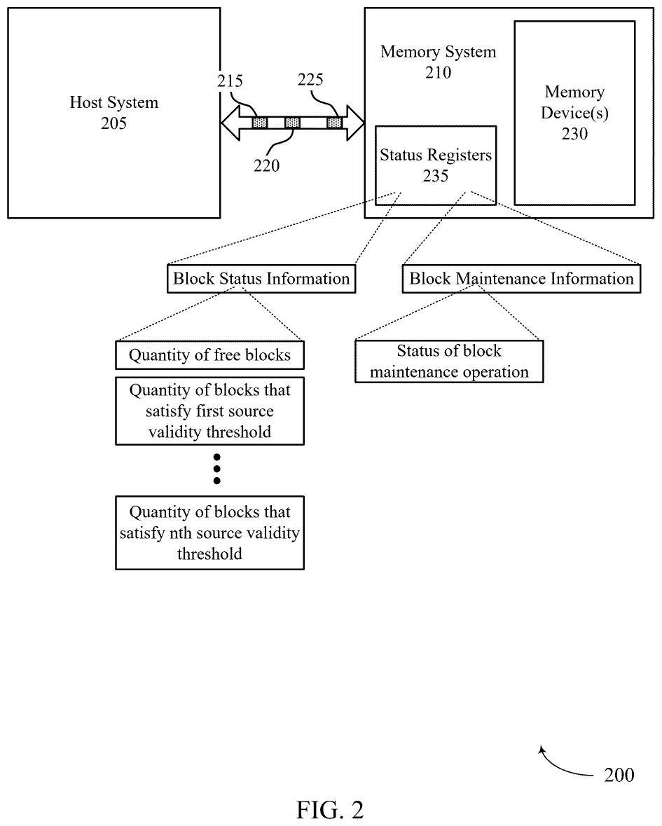

FIG. 2 shows an example of a system 200 that supports host-controlled block maintenance operations in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 230 to store data transferred between the memory system 210 and the host system 205 (e.g., in response to receiving access commands from the host system 205). The memory devices 230 may include one or more memory devices as described with reference to FIG. 1. Together, the memory devices 230 may include a quantity of blocks that provide the storage capacity of the memory system 210. As data is written to the memory system 210 (e.g., on a page-basis) and updated, the amount of valid data stored in the blocks may vary (e.g., some blocks may have higher amounts of valid data and other blocks may have lower amounts of valid data).

To condense the valid data and free up (e.g., erase) additional blocks for writing, the memory system 210 may perform a block maintenance operation in which valid data from source blocks is written to destination blocks and then the source blocks are erased on a block-basis. For a background maintenance operation, the destination blocks may be blocks that are already erased and the source blocks may be blocks whose valid data is less than the source validity threshold of the memory system 210 (e.g., blocks that fail to satisfy the source validity threshold). For a foreground maintenance operation, the destination blocks may be blocks that are already erased and the source blocks may be blocks whose valid data is greater than the source validity threshold of the memory system 210 (e.g., blocks that satisfy the source validity threshold).

Rather than use a static source validity threshold, which may not accommodate a performance metric targeted by the host system 205, the memory system 210 may use a dynamically selected source validity threshold. The source validity threshold may be selected by the host system 205 based on (e.g., due to) block status information 220 received from the memory system 210. For example, the memory system 210 may transmit (e.g., in response to a request 215 from the host system 205) an indication of the quantity (e.g., the total quantity) of free blocks at the memory system 210, where free blocks refer to blocks that are currently in an erased state (and thus are ready to be written). The memory system 210 may also transmit (e.g., in response to the request 215) an indication of the quantity of blocks (Quantity1) that satisfy a first source validity threshold (e.g., individually store more valid data than the first source validity threshold), an indication of the quantity of blocks (Quantity2) that satisfy a second source validity threshold (e.g., individually store more valid data than a second source validity threshold), or both. Additionally, or alternatively, the memory system 210 may transmit an indication of the quantity of blocks that fail to satisfy the first source validity threshold, and indication of the quantity of blocks that fail to satisfy the second source validity threshold, or both.

Although described with reference to a single request 215, the host system 205 may transmit any quantity of requests for the block status information. In some examples, the request(s) may indicate the source validity threshold(s) for which the block status information is requested. Although described with reference to a first source validity threshold and a second source validity threshold, the block status information may be for any quantity of source validity thresholds.

The host system 205 may use the block status information to determine one or more expected performance metrics for the memory system 210 that are associated with block maintenance operations. For example, the host system 205 may determine a first expected performance metric (e.g., a first available storage capacity) based on (e.g., using) the quantity of free blocks and Quantity1 (e.g., the quantity of blocks that satisfy the first source validity threshold). The host system 205 may also determine a second expected performance metric (e.g., a second available storage capacity) based on (e.g., using) the quantity of free blocks and Quantity2 (e.g., the quantity of blocks that satisfy the second source validity threshold). The host system 205 may then select a source validity threshold (e.g., the first source validity threshold or the second source validity threshold) for use by the memory system 210 based on the expected performance metrics and a target performance metric selected by the host system 205. For example, the host system 205 may select the source validity threshold that satisfies the target performance metric.

A performance metric may be an available storage capacity of the memory system 210, a latency for performing a block maintenance operation at the memory system 210, a data rate supported by the memory system 210 (e.g., during foreground operation), or any combination thereof, among other potential metrics. Because the performance metrics of the memory system 210 may vary with the source validity threshold used for block maintenance operations, the host system 205 may determine an expected performance metric for a given source validity threshold based on the quantity of blocks that satisfy (e.g., individually store more valid data than) that source validity threshold. For instance, to determine the expected available storage capacity of the memory system for a first source validity threshold (e.g., 95%), the host system 205 may estimate (e.g., based on the individual storage capacity of the free blocks) how many free blocks would be consumed by the collective amount of valid data stored in the source blocks for the first source validity threshold (e.g., the blocks that individually store more valid data than the first source validity threshold). The host system 205 may then calculate how many blocks would ultimately be freed up (e.g., made available for writing) if the memory system 210 used the first source validity threshold. For instance, the host system 205 may subtract the quantity of consumed blocks from the quantity of freed (e.g., source) blocks. So, if two blocks are freed and one block is consumed by a block maintenance operation using the first source validity threshold, the overall gain in available storage capacity may be equal to the storage capacity of one block.

Thus, the host system 205 may select the source validity threshold based on (e.g., as a function of) the collective storage capacity of the quantity of free blocks, the collective storage capacity of the first quantity of blocks, the collective amount of valid data stored at the first quantity of blocks, or any combination thereof.

After selecting the source validity threshold for the memory system 210, the host system 205 may transmit an indication that the memory system 210 is to perform the background maintenance operation using the selected source validity threshold. For example, the host system 205 may transmit background maintenance trigger 225 (e.g., a flag, an indication). If the selected source validity threshold is already the default source validity threshold (or is the only source validity threshold evaluated by the host system 205), the background maintenance trigger 225 may not indicate the selected source validity threshold. Otherwise, the background maintenance trigger 225 may indicate the selected source validity threshold. The memory system 210 may then use the indicated source validity threshold for block maintenance operations. For example, the memory system 210 may select blocks as source blocks for background block maintenance operations based on (e.g., due to) the blocks individually storing less valid data than the source validity threshold. If the quantity of free blocks falls below a threshold quantity during foreground operations, the memory system 210 may select blocks as source blocks for foreground block maintenance operations based on (e.g., due to) the blocks individually storing more valid data than the source validity threshold.

In some examples (e.g., after indicating the source validity threshold), the host system 205 may request that the memory system 210 pause or cease performing the block maintenance operation. Accordingly, the memory system 210 may pause or cease performing the block maintenance operation. In such examples, the host system 205 may request re-initiation of the block maintenance operation using the same source validity threshold or a different source validity threshold.

The memory system 210 may track the block status information in one or more registers, such as status registers 235. For example, as the memory system 210 writes data to blocks (e.g., on a page-basis) and erases blocks (e.g., on a block basis), the memory system 210 may update register information that indicates the current quantity of free blocks at the memory system 210. Similarly, the memory system 210 may also update register information that indicates the quantities of blocks that satisfy various source validity thresholds (e.g., n source validity thresholds, where n is a positive integer). For example, the memory system 210 may update register information that indicates the quantity of blocks that satisfy a first source validity threshold, may update register information that indicates the quantity of blocks that satisfy the nth source validity threshold, and may update register information for source validity thresholds between the first source validity threshold and the nth source validity threshold. The memory system 210 may determine the source validity threshold(s) to track based on (e.g., responsive to) indications of the source validity threshold(s) received from the host system 205. Register information may also be referred to as attributes or other suitable terminology.

In some examples, the memory system 210 may track additional status information in the status registers 235. For example, the memory system 210 may track the status of a background block maintenance operation and update register information, referred to as block maintenance information, that indicates the status of the background block maintenance operation. For instance, the block maintenance information may indicate whether the block maintenance operation is idle, ongoing, paused, or complete.

Thus, the host system 205 may dynamically select the source validity threshold for a background maintenance operation performed by the memory system 210.

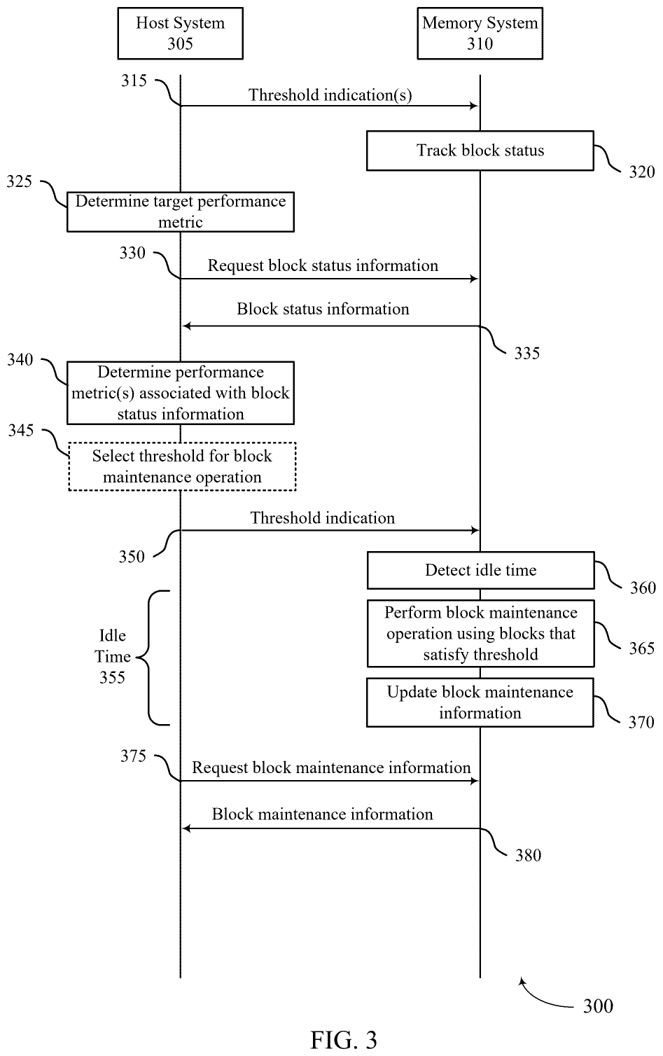

FIG. 3 shows an example of a process flow 300 that supports host-controlled block maintenance operations in accordance with examples as disclosed herein. The process flow 300 may be implemented by a host system 305, which may be an example of a host system 105 or a host system 205, and a memory system 310, which may be an example of a memory system 110 or a memory system 210. The host system 305 and the memory system 310 may exchange information to enable a background block maintenance operation that uses a dynamically selected source block validity threshold. In some examples, the memory system 310 may have a configured or default source block validity threshold at the start of the process flow 300.

Aspects of the process flow 300 may be implemented by one or more controllers, among other components. Additionally, or alternatively, aspects of the process flow 300 may be implemented as instructions stored in one or more memories (e.g., firmware stored in one or more memories coupled with the host system 305, firmware stored in one or more memories coupled with the memory system 310). For example, the instructions, if executed by one or more controllers (e.g., the host system controller 106, the memory system controller 115, a local controller 135), may cause the one or more controllers (or a device or a system) to perform the operations of the process flow 300.

At 315, an indication of one or more source validity thresholds for the memory system 310 to monitor may be transmitted (e.g., by the host system 305). Each source validity threshold may represent a threshold amount of valid data. At 320 and after, the status of blocks that satisfy the source validity thresholds may be tracked (e.g., by the memory system 310). For example, the memory system 310 may determine (e.g., count) a first quantity (e.g., amount, number) of blocks that satisfy a first source validity threshold, a second quantity of blocks that satisfy a second source validity threshold, and so on. The memory system 310 may also track the quantity of free blocks (e.g., currently erased blocks). Additionally, or alternatively, the memory system 310 may determine a third quantity of blocks that fail to satisfy the first source validity threshold, a fourth quantity of blocks that fail to satisfy the second source validity threshold, and so on. The memory system 310 may update one or more registers to indicate the various quantities of blocks.

In some examples, a block that is counted towards one source validity threshold may also be counted towards a second source validity threshold (e.g., the block may satisfy two or more source validity thresholds). For instance, if the first source validity threshold is 60% and the second source validity threshold is 75%, a block that has 85% valid data may satisfy both source validity thresholds whereas a block that has 65% valid data may satisfy the first source validity threshold but not the second source validity threshold.

At 325, a target performance metric (e.g., a storage capacity, a response latency, a data rate) for the memory system 310 may be determined (e.g., by the host system 305). The host system 305 may determine the target performance metric based on (e.g., as a function of, responsive to) a pending or expected set of data or access commands for the memory system 310. For instance, the host system 305 may determine a target storage capacity based on (e.g., as a function of) the size of a file (e.g., set of data) that the host system 305 has queued for writing (or expects to write).

At 330, one or more request(s) for block status information from the memory system 310 may be transmitted (e.g., by the host system 305). For instance, the host system 305 may request that the memory system 310 transmit an indication of the quantity of free blocks, an indication of the quantities of blocks that satisfy the one or more source validity thresholds, an indication of the quantities of blocks that fail to satisfy the one or more source validity thresholds, or any combination thereof.

At 335, the block status information may be transmitted (e.g., by the memory system 310 to the host system 305) based on (e.g., in response to) the request(s) at 330. The block status information may comprise an indication of the quantity of free blocks (e.g., erased blocks), an indication of the first quantity of blocks that satisfy the first source validity threshold, an indication of the second quantity of blocks that satisfy the second source validity threshold, or any combination thereof. Additionally, or alternatively, the block status information may comprise an indication of the third quantity of blocks that fail to satisfy the first source validity threshold, an indication of the fourth quantity of blocks that fail to satisfy the second source validity threshold, or both. Alternatively, the host system 305 may determine the third quantity of blocks based on (e.g., as a function of) the first quantity of blocks, the quantity of free blocks, and the total quantity of blocks. Similarly, the host system 305 may determine the fourth quantity of blocks based on (e.g., as a function of) the second quantity of blocks, the quantity of free blocks, and the total quantity of blocks.

At 340, one or more expected performance metrics (e.g., storage capacity, data rate, response latency) for the memory system 310 may be determined (e.g., by the host system 305) based on (e.g., as a function of) the block status information. For example, the host system 305 may determine a first expected performance metric based on (e.g., as a function of) the quantity of free blocks, the first quantity of blocks that satisfy the first source validity threshold, the third quantity of blocks that fail to satisfy the first source validity threshold, or any combination thereof. Similarly, the host system 305 may determine a second expected performance metric based on (e.g., as a function of) the quantity of free blocks, the second quantity of blocks that satisfy the second source validity threshold, the fourth quantity of blocks that fail to satisfy the second source validity threshold, or any combination thereof.

At 345, a source validity threshold for the memory system 310 to use for block maintenance operations may be selected (e.g., by the host system 305). The host system 305 may select one of the source validity thresholds (e.g., the first source validity threshold, the second source validity threshold) for which block status information was received at 335. The host system 305 may select the source validity threshold based on (e.g., due to) the expected performance metric associated with that source validity threshold as determined at 340. For instance, the host system 305 may select the first source validity threshold as the source validity threshold based on (e.g., due to) the first source validity threshold having an associated expected performance metric that satisfies the target performance metric determined at 325.

At 350, an indication that the memory system 310 is to perform background block maintenance operations using the selected source validity threshold may be transmitted (e.g., by the host system 305). If the selected source validity threshold is already the default source validity threshold (or is the only source validity threshold evaluated by the host system 305), the indication at 350 may not indicate the selected source validity threshold. Otherwise, the indication at 350 may indicate the selected source validity threshold.

At 360, an idle time (e.g., idle time 355) may be detected (e.g., by the memory system 310). For example, the memory system 310 may detect a window of time during which access commands (e.g., commands that prompt the memory system 310 to access the memory devices of the memory system 310, such as read commands, write commands, sync cache commands) from the host system 305 are paused for at least a threshold duration. The memory system may detect the idle time based on (e.g., due to) detecting a pause between adjacent access commands that lasts at least the threshold duration. The idle time may last until receipt of an access command.

At 365, one or more background block maintenance operations may be performed (e.g., by the memory system 310) using the source validity threshold. For example, the memory system 310 may copy valid data from one or more source blocks (e.g., blocks that fail to satisfy the source validity threshold) to one or more destination blocks (e.g., erased blocks). The memory system 310 may then erase the source blocks from which the valid data was copied. At 370, block maintenance information in one or more registers may be updated (e.g., by the memory system 310). The memory system 310 may update the block maintenance information to indicate the status of the block maintenance operation (e.g., whether the block maintenance operation is idle, ongoing, paused, or complete). In some examples, the memory system 310 may also update block status information (e.g., in one or more registers) to indicate new quantities of free blocks, blocks that satisfy the various source validity thresholds, or blocks that fail to satisfy the various source validity thresholds.

At 375, block maintenance information from the memory system 310 may be requested (e.g., by the host system 305). At 380, the block maintenance information may be transmitted (e.g., by the memory system 310 to the host system 305) in response to the request at 375. In some examples, the host system 305 may request that the memory system 310 pause or cease performing the block maintenance operation. Accordingly, the memory system 310 may pause or cease performing the block maintenance operation. In such examples, the host system 305 may request re-initiation of the block maintenance operation using the same source validity threshold or a different source validity threshold.

Thus, the host system 305 and the memory system 310 may exchange information to enable a background block maintenance operation that uses a dynamically selected source block validity threshold. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

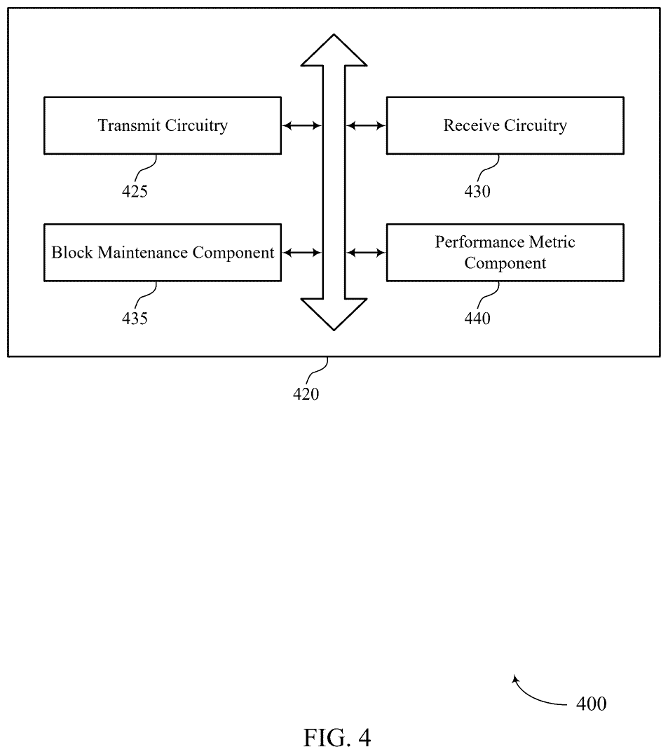

FIG. 4 shows a block diagram 400 of a host system 420 that supports host-controlled block maintenance operations in accordance with examples as disclosed herein. The host system 420 may be an example of aspects of a host system as described with reference to FIGS. 1 through 3. The host system 420, or various components thereof, may be an example of means for performing various aspects of host-controlled block maintenance operations as described herein. For example, the host system 420 may include a transmit circuitry 425, a receive circuitry 430, a block maintenance component 435, a performance metric component 440, or any combination thereof. Each of these components, or components of subcomponents thereof (e.g., one or more processors, one or more memories), may communicate, directly or indirectly, with one another (e.g., via one or more buses).

The transmit circuitry 425 may be configured as or otherwise support a means for transmitting a request for block status information to a memory system. The receive circuitry 430 may be configured as or otherwise support a means for receiving the block status information in response to transmitting the request, the block status information including an indication of a first quantity of blocks available for writing and an indication of a second quantity of blocks written with at least a threshold amount of valid data. The block maintenance component 435 may be configured as or otherwise support a means for transmitting, in accordance with the block status information and a target performance metric, an indication for the memory system to perform, during an idle time, a block maintenance operation in which data stored at the second quantity of blocks is copied to a subset of the first quantity of blocks and in which the second quantity of blocks are erased after the data stored at the second quantity of blocks is copied.

In some examples, the idle time includes a window of time during which access commands from a host system are paused for at least a threshold duration.

In some examples, the target performance metric includes a storage capacity metric, a latency metric, or a data rate metric, or any combination thereof.

In some examples, the transmit circuitry 425 may be configured as or otherwise support a means for transmitting an indication of the threshold amount, where the request for block status information is transmitted in response to transmitting the indication of the threshold amount.

In some examples, the block maintenance component 435 may be configured as or otherwise support a means for transmitting a request for block maintenance information in response to transmitting the indication to perform the block maintenance operation. In some examples, the receive circuitry 430 may be configured as or otherwise support a means for receiving the block maintenance information in response to transmitting the request for the block maintenance information, the block maintenance information indicating a status of the block maintenance operation.

In some examples, the block maintenance component 435 may be configured as or otherwise support a means for transmitting, in accordance with the block maintenance information, an indication for the memory system to cease performing the block maintenance operation.

In some examples, the performance metric component 440 may be configured as or otherwise support a means for determining a performance metric associated with the first quantity of blocks and the second quantity of blocks, where the indication to perform the block maintenance operation is transmitted in accordance with the performance metric.

In some examples, the block maintenance component 435 may be configured as or otherwise support a means for determining a collective storage capacity of the first quantity of blocks, a collective storage capacity of the second quantity of blocks, or a collective amount of valid data stored at the second quantity of blocks, or any combination thereof, where the indication to perform the block maintenance operation is transmitted in accordance with the collective storage capacity of the first quantity of blocks, the collective storage capacity of the second quantity of blocks, or the collective amount of valid data stored at the second quantity of blocks, or any combination thereof.

In some examples, the block status information includes a third quantity of blocks written with at least a second threshold amount of valid data. In some examples, the indication to perform the block maintenance operation indicates the threshold amount.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by such at least one processor.

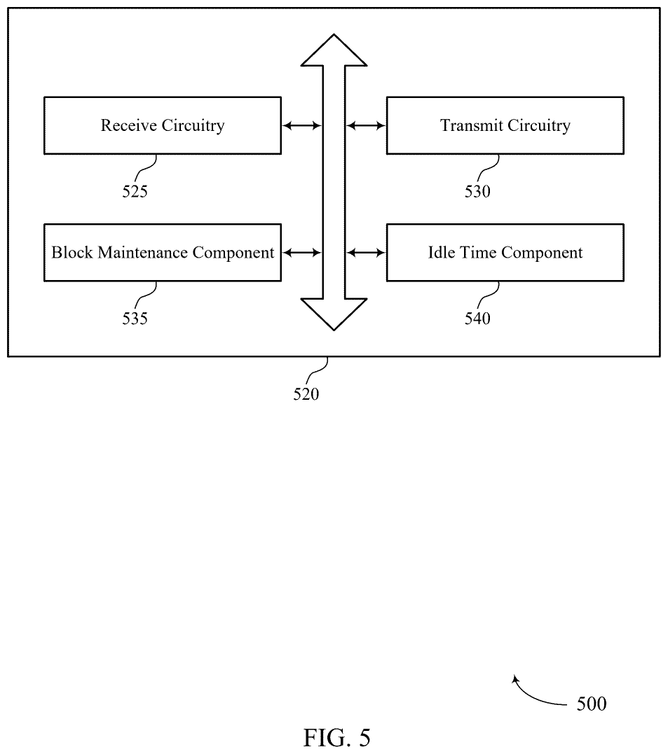

FIG. 5 shows a block diagram 500 of a memory system 520 that supports host-controlled block maintenance operations in accordance with examples as disclosed herein. The memory system 520 may be an example of aspects of a memory system as described with reference to FIGS. 1 through 3. The memory system 520, or various components thereof, may be an example of means for performing various aspects of host-controlled block maintenance operations as described herein. For example, the memory system 520 may include a receive circuitry 525, a transmit circuitry 530, a block maintenance component 535, an idle time component 540, or any combination thereof. Each of these components, or components of subcomponents thereof (e.g., one or more processors, one or more memories), may communicate, directly or indirectly, with one another (e.g., via one or more buses).

The receive circuitry 525 may be configured as or otherwise support a means for receiving a request for block status information from a host system. The transmit circuitry 530 may be configured as or otherwise support a means for transmitting the block status information in response to receiving the request, the block status information including an indication of a first quantity of blocks available for writing and an indication of a second quantity of blocks written with at least a threshold amount of valid data. The block maintenance component 535 may be configured as or otherwise support a means for receiving, in response to transmitting the block status information, an indication to perform, during an idle time, a block maintenance operation in which data stored at the second quantity of blocks is copied to a subset of the first quantity of blocks and in which the second quantity of blocks are erased after the data stored at the second quantity of blocks is copied.

In some examples, the idle time component 540 may be configured as or otherwise support a means for detecting a window of time as the idle time in response to determining that access commands from a host system have been paused for at least a threshold duration. In some examples, the block maintenance component 535 may be configured as or otherwise support a means for performing the block maintenance operation during the window of time in response to the indication.

In some examples, the receive circuitry 525 may be configured as or otherwise support a means for receiving an indication of the threshold amount, where the indication of the second quantity of blocks is transmitted in response to receiving the indication of the threshold amount.

In some examples, the block maintenance component 535 may be configured as or otherwise support a means for receiving a request for block maintenance information in response to receiving the indication to perform the block maintenance operation. In some examples, the transmit circuitry 530 may be configured as or otherwise support a means for transmitting the block maintenance information in response to receiving the request for the block maintenance information, the block maintenance information indicating a status of the block maintenance operation.

In some examples, the receive circuitry 525 may be configured as or otherwise support a means for receiving, in response to transmitting the block maintenance information, an indication to cease performing the block maintenance operation. In some examples, the block maintenance component 535 may be configured as or otherwise support a means for ceasing performing the block maintenance operation in response to receiving the indication to cease performing the block maintenance operation.

In some examples, the block status information includes a third quantity of blocks written with at least a second threshold amount of valid data. In some examples, the indication to perform the block maintenance operation indicates the threshold amount.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

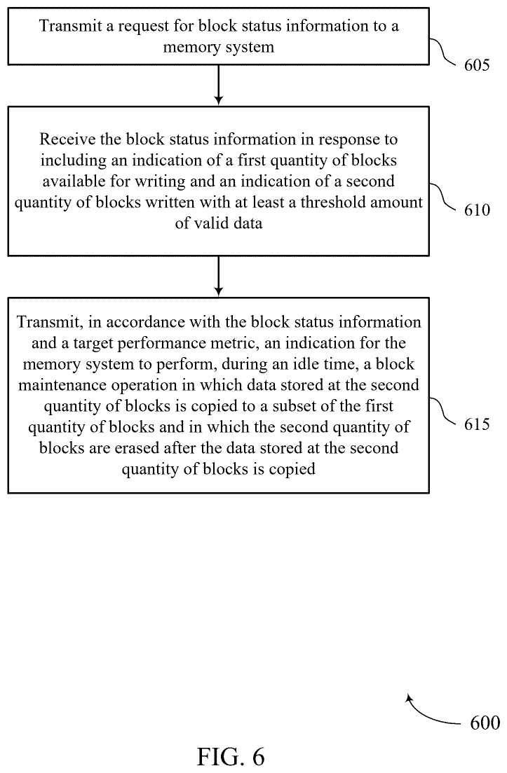

FIG. 6 shows a flowchart illustrating a method 600 that supports host-controlled block maintenance operations in accordance with examples as disclosed herein. The operations of method 600 may be implemented by a host system or its components as described herein. For example, the operations of method 600 may be performed by a host system as described with reference to FIGS. 1 through 4. In some examples, a host system may execute a set of instructions to control the functional elements of the device to perform the described functions. Additionally, or alternatively, the host system may perform aspects of the described functions using special-purpose hardware.

At 605, the method may include transmitting a request for block status information to a memory system. In some examples, aspects of the operations of 605 may be performed by a transmit circuitry 425 as described with reference to FIG. 4.

At 610, the method may include receiving the block status information in response to transmitting the request, the block status information including an indication of a first quantity of blocks available for writing and an indication of a second quantity of blocks written with at least a threshold amount of valid data. In some examples, aspects of the operations of 610 may be performed by a receive circuitry 430 as described with reference to FIG. 4.

At 615, the method may include transmitting, in accordance with the block status information and a target performance metric, an indication for the memory system to perform, during an idle time, a block maintenance operation in which data stored at the second quantity of blocks is copied to a subset of the first quantity of blocks and in which the second quantity of blocks are erased after the data stored at the second quantity of blocks is copied. In some examples, aspects of the operations of 615 may be performed by a block maintenance component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting a request for block status information to a memory system; receiving the block status information in response to transmitting the request, the block status information including an indication of a first quantity of blocks available for writing and an indication of a second quantity of blocks written with at least a threshold amount of valid data; and transmitting, in accordance with the block status information and a target performance metric, an indication for the memory system to perform, during an idle time, a block maintenance operation in which data stored at the second quantity of blocks is copied to a subset of the first quantity of blocks and in which the second quantity of blocks are erased after the data stored at the second quantity of blocks is copied.

Aspect 2: The method, apparatus, or non-transitory computer-readable medium of aspect 1, where the idle time includes a window of time during which access commands from a host system are paused for at least a threshold duration.

Aspect 3: The method, apparatus, or non-transitory computer-readable medium of any of aspects 1 through 2, where the target performance metric includes a storage capacity metric, a latency metric, or a data rate metric, or any combination thereof.

Aspect 4: The method, apparatus, or non-transitory computer-readable medium of any of aspects 1 through 3, further including operations, features, circuitry, logic, means, or instructions, or any combination thereof for transmitting an indication of the threshold amount, where the request for block status information is transmitted in response to transmitting the indication of the threshold amount.

Aspect 5: The method, apparatus, or non-transitory computer-readable medium of any of aspects 1 through 4, further including operations, features, circuitry, logic, means, or instructions, or any combination thereof for transmitting a request for block maintenance information in response to transmitting the indication to perform the block maintenance operation and receiving the block maintenance information in response to transmitting the request for the block maintenance information, the block maintenance information indicating a status of the block maintenance operation.

Aspect 6: The method, apparatus, or non-transitory computer-readable medium of aspect 5, further including operations, features, circuitry, logic, means, or instructions, or any combination thereof for transmitting, in accordance with the block maintenance information, an indication for the memory system to cease performing the block maintenance operation.

Aspect 7: The method, apparatus, or non-transitory computer-readable medium of any of aspects 1 through 6, further including operations, features, circuitry, logic, means, or instructions, or any combination thereof for determining a performance metric associated with the first quantity of blocks and the second quantity of blocks, where the indication to perform the block maintenance operation is transmitted in accordance with the performance metric.

Aspect 8: The method, apparatus, or non-transitory computer-readable medium of any of aspects 1 through 7, further including operations, features, circuitry, logic, means, or instructions, or any combination thereof for determining a collective storage capacity of the first quantity of blocks, a collective storage capacity of the second quantity of blocks, or a collective amount of valid data stored at the second quantity of blocks, or any combination thereof, where the indication to perform the block maintenance operation is transmitted in accordance with the collective storage capacity of the first quantity of blocks, the collective storage capacity of the second quantity of blocks, or the collective amount of valid data stored at the second quantity of blocks, or any combination thereof.

Aspect 9: The method, apparatus, or non-transitory computer-readable medium of any of aspects 1 through 8, where the block status information includes a third quantity of blocks written with at least a second threshold amount of valid data and the indication to perform the block maintenance operation indicates the threshold amount.

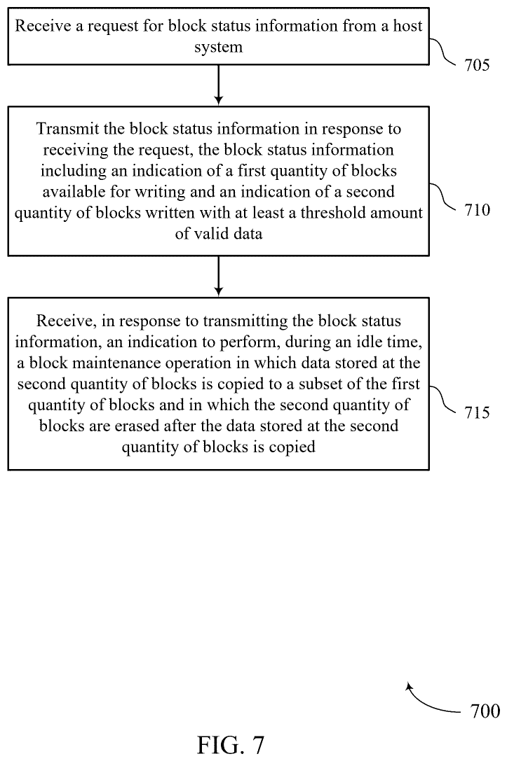

FIG. 7 shows a flowchart illustrating a method 700 that supports host-controlled block maintenance operations in accordance with examples as disclosed herein. The operations of method 700 may be implemented by a memory system or its components as described herein. For example, the operations of method 700 may be performed by a memory system as described with reference to FIGS. 1 through 3 and 5. In some examples, a memory system may execute a set of instructions to control the functional elements of the device to perform the described functions. Additionally, or alternatively, the memory system may perform aspects of the described functions using special-purpose hardware.

At 705, the method may include receiving a request for block status information from a host system. In some examples, aspects of the operations of 705 may be performed by a receive circuitry 525 as described with reference to FIG. 5.

At 710, the method may include transmitting the block status information in response to receiving the request, the block status information including an indication of a first quantity of blocks available for writing and an indication of a second quantity of blocks written with at least a threshold amount of valid data. In some examples, aspects of the operations of 710 may be performed by a transmit circuitry 530 as described with reference to FIG. 5.

At 715, the method may include receiving, in response to transmitting the block status information, an indication to perform, during an idle time, a block maintenance operation in which data stored at the second quantity of blocks is copied to a subset of the first quantity of blocks and in which the second quantity of blocks are erased after the data stored at the second quantity of blocks is copied. In some examples, aspects of the operations of 715 may be performed by a block maintenance component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving a request for block status information from a host system; transmitting the block status information in response to receiving the request, the block status information including an indication of a first quantity of blocks available for writing and an indication of a second quantity of blocks written with at least a threshold amount of valid data; and receiving, in response to transmitting the block status information, an indication to perform, during an idle time, a block maintenance operation in which data stored at the second quantity of blocks is copied to a subset of the first quantity of blocks and in which the second quantity of blocks are erased after the data stored at the second quantity of blocks is copied.

Aspect 11: The method, apparatus, or non-transitory computer-readable medium of aspect 10, further including operations, features, circuitry, logic, means, or instructions, or any combination thereof for detecting a window of time as the idle time in response to determining that access commands from a host system have been paused for at least a threshold duration and performing the block maintenance operation during the window of time in accordance with the indication.

Aspect 12: The method, apparatus, or non-transitory computer-readable medium of any of aspects 10 through 11, further including operations, features, circuitry, logic, means, or instructions, or any combination thereof for receiving an indication of the threshold amount, where the indication of the second quantity of blocks is transmitted in response to receiving the indication of the threshold amount.

Aspect 13: The method, apparatus, or non-transitory computer-readable medium of any of aspects 10 through 12, further including operations, features, circuitry, logic, means, or instructions, or any combination thereof for receiving a request for block maintenance information in response to receiving the indication to perform the block maintenance operation and transmitting the block maintenance information in response to receiving the request for the block maintenance information, the block maintenance information indicating a status of the block maintenance operation.

Aspect 14: The method, apparatus, or non-transitory computer-readable medium of aspect 13, further including operations, features, circuitry, logic, means, or instructions, or any combination thereof for receiving, in response to transmitting the block maintenance information, an indication to cease performing the block maintenance operation and ceasing performing the block maintenance operation in response to receiving the indication to cease performing the block maintenance operation.

Aspect 15: The method, apparatus, or non-transitory computer-readable medium of any of aspects 10 through 14, where the block status information includes a third quantity of blocks written with at least a second threshold amount of valid data and the indication to perform the block maintenance operation indicates the threshold amount.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
one or more controllers coupled with the one or more memory devices and configured to cause the memory system to:
receive a request for block status information from a host system;
transmit the block status information in response to receiving the request, the block status information comprising an indication of a first quantity of blocks available for writing and an indication of a second quantity of blocks written with at least a threshold amount of valid data; and
receive, in response to transmitting the block status information, an indication to perform, during an idle time, a block maintenance operation in which data stored at the second quantity of blocks is copied to a subset of the first quantity of blocks and in which the second quantity of blocks are erased after the data stored at the second quantity of blocks is copied.

2. The memory system of claim 1, wherein the one or more controllers is further configured to cause the memory system to:
detect a window of time as the idle time in response to determining that access commands from a host system have been paused for at least a threshold duration; and
perform the block maintenance operation during the window of time in response to the indication.

3. The memory system of claim 1, wherein the one or more controllers is further configured to cause the memory system to:
receive an indication of the threshold amount, wherein the indication of the second quantity of blocks is transmitted in response to receiving the indication of the threshold amount.

4. The memory system of claim 1, wherein the one or more controllers is further configured to cause the memory system to:
receive a request for block maintenance information in response to receiving the indication to perform the block maintenance operation; and
transmit the block maintenance information in response to receiving the request for the block maintenance information, the block maintenance information indicating a status of the block maintenance operation.

5. The memory system of claim 4, wherein the one or more controllers is further configured to cause the memory system to:
receive, in response to transmitting the block maintenance information, an indication to cease performing the block maintenance operation; and
cease performing the block maintenance operation in response to receiving the indication to cease performing the block maintenance operation.

6. The memory system of claim 1, wherein the block status information comprises a third quantity of blocks written with at least a second threshold amount of valid data, and wherein the indication to perform the block maintenance operation indicates the threshold amount.

7. An apparatus, comprising:
one or more controllers configured to couple with a memory system, wherein the one or more controllers is configured to cause to the apparatus to:
transmit a request for block status information to a memory system;
receive the block status information in response to transmitting the request, the block status information comprising an indication of a first quantity of blocks available for writing and an indication of a second quantity of blocks written with at least a threshold amount of valid data; and
transmit, in accordance with the block status information and a target performance metric, an indication for the memory system to perform, during an idle time, a block maintenance operation in which data stored at the second quantity of blocks is copied to a subset of the first quantity of blocks and in which the second quantity of blocks are erased after the data stored at the second quantity of blocks is copied.

8. The apparatus of claim 7, wherein the idle time comprises a window of time during which access commands from a host system are paused for at least a threshold duration.

9. The apparatus of claim 7, wherein the target performance metric comprises a storage capacity metric, a latency metric, or a data rate metric, or any combination thereof.

10. The apparatus of claim 7, wherein the one or more controllers is further configured to cause the apparatus to:
transmit an indication of the threshold amount, wherein the request for block status information is transmitted in response to transmitting the indication of the threshold amount.

11. The apparatus of claim 7, wherein the one or more controllers is further configured to cause the apparatus to:
transmit a request for block maintenance information in response to transmitting the indication to perform the block maintenance operation; and
receive the block maintenance information in response to transmitting the request for the block maintenance information, the block maintenance information indicating a status of the block maintenance operation.

12. The apparatus of claim 11, wherein the one or more controllers is further configured to cause the apparatus to:
transmit, in accordance with the block maintenance information, an indication for the memory system to cease performing the block maintenance operation.

13. The apparatus of claim 7, wherein the one or more controllers is further configured to cause the apparatus to:
determine a performance metric associated with the first quantity of blocks and the second quantity of blocks, wherein the indication to perform the block maintenance operation is transmitted in accordance with the performance metric.

14. The apparatus of claim 7, wherein the one or more controllers is further configured to cause the apparatus to:
determine a collective storage capacity of the first quantity of blocks, a collective storage capacity of the second quantity of blocks, or a collective amount of valid data stored at the second quantity of blocks, or any combination thereof, wherein the indication to perform the block maintenance operation is transmitted in accordance with the collective storage capacity of the first quantity of blocks, the collective storage capacity of the second quantity of blocks, or the collective amount of valid data stored at the second quantity of blocks, or any combination thereof.

15. The apparatus of claim 7, wherein the block status information comprises a third quantity of blocks written with at least a second threshold amount of valid data, and wherein the indication to perform the block maintenance operation indicates the threshold amount.

16. A method, comprising:
receiving a request for block status information from a host system;
transmitting the block status information in response to receiving the request, the block status information comprising an indication of a first quantity of blocks available for writing and an indication of a second quantity of blocks written with at least a threshold amount of valid data; and
receiving, in response to transmitting the block status information, an indication to perform, during an idle time, a block maintenance operation in which data stored at the second quantity of blocks is copied to a subset of the first quantity of blocks and in which the second quantity of blocks are erased after the data stored at the second quantity of blocks is copied.

17. The method of claim 16, further comprising:
detecting a window of time as the idle time in response to determining that access commands from a host system have been paused for at least a threshold duration; and
performing the block maintenance operation during the window of time in response to the indication.

18. The method of claim 16, further comprising:
receiving an indication of the threshold amount, wherein the indication of the second quantity of blocks is transmitted in response to receiving the indication of the threshold amount.

19. The method of claim 16, further comprising:
receiving a request for block maintenance information in response to receiving the indication to perform the block maintenance operation; and
transmitting the block maintenance information in response to receiving the request for the block maintenance information, the block maintenance information indicating a status of the block maintenance operation.

20. The method of claim 19, further comprising:
receiving, in response to transmitting the block maintenance information, an indication to cease performing the block maintenance operation; and
ceasing performing the block maintenance operation in response to receiving the indication to cease performing the block maintenance operation.

21. The method of claim 16, wherein the block status information comprises a third quantity of blocks written with at least a second threshold amount of valid data, and wherein the indication to perform the block maintenance operation indicates the threshold amount.
